(19) United States
(12) Patent Application Publication
(10) Pub. No.: US 2025/0095041 A1
(43) Pub. Date: Mar. 20, 2025

(54) NEGOTIATION APPARATUS, NEGOTIATION METHOD, AND NON-TRANSITORY COMPUTER-READABLE STORAGE MEDIUM

(71) Applicants: NEC Corporation, Tokyo (JP); NATIONAL INSTITUTE OF ADVANCED INDUSTRIAL SCIENCE AND TECHNOLOGY, Tokyo (JP)

(72) Inventors: Kai GUO, Tokyo (JP); Shinji NAKADAI, Tokyo (JP)

(73) Assignees: NEC Corporation, Tokyo (JP); NATIONAL INSTITUTE OF ADVANCED INDUSTRIAL SCIENCE AND TECHNOLOGY, Tokyo (JP)

(21) Appl. No.: 18/724,084

(22) PCT Filed: Dec. 26, 2022
(86) PCT No.: PCT/JP2022/047934

§ 371 Date: Jun. 25, 2024

(30) Foreign Application Priority Data
Dec. 28, 2021 (JP) 2021-214132

(51) Int. Cl. G06Q 30/0601; G06Q 50/18

(52) U.S. Cl. CPC G06Q 30/0611; G06Q 50/188

(57) ABSTRACT

A negotiation apparatus acquires history information that indicates a proposal time of a current offer from an opponent agent and a utility of each offer from the opponent agent that has been received in a negotiation. In the negotiation, a maximum length of time of the negotiation period is fixed in advance. The negotiation apparatus generates a probability distribution of the number of future offers based on the length of time of the remaining period of the negotiation and the proposal time of the current offer. The negotiation apparatus computes an expected utility of future offers based on the probability distribution of the number of future offers and the utilities indicated by the history information. The negotiation apparatus determines whether or not to accept the current offer based on the expected utility of future offers and the utility of the current offer.

### TECHNICAL FIELD

The present disclosure generally relates to automated negotiation.

### BACKGROUND ART

Techniques related to automated negotiation have been developed. In the automated negotiation, an agent provides an offer to its opponent, and the opponent accepts or rejects the offer. NPL1 discloses a technique of determining whether or not to accept an offer based on a utility of the offer, which represents how preferable the offer is for the agent that receives the offer.

### CITATION LIST

### Non Patent Literature

NPL1: Tim Baarslag and Koen Hindriks, “Accepting Optimally in Automated Negotiation with Incomplete Information”, Proceedings of the 12th International Conference on Autonomous Agents and Multiagent Systems (AA-MAS 2013), May 6, 2013

### SUMMARY OF INVENTION

### Technical Problem

NPL 1 assumes that the maximum number of offers is fixed in advance as a rule of the negotiation. The present disclosure provides a novel technique to appropriately determine whether or not to accept an offer in the negotiation.

### Solution to Problem

The present disclosure provides a first negotiation apparatus comprising at least one processor and memory storing instructions. The at least one processor is configured to execute the instructions to: acquire history information that indicates a proposal time of a current offer from an opponent and a utility of each offer from the opponent that have been received in a negotiation, a maximum length of time of a period of the negotiation being fixed in advance; generate a probability distribution of a number of future offers based on a length of time of a remaining period of the negotiation and the proposal time of the current offer; compute an expected utility of future offers based on the probability distribution of the number of future offers and the utilities indicated by the history information; and determine whether or not to accept the current offer based on the expected utility of future offer and the utility of the current offer.

The present disclosure provides a second negotiation apparatus comprising at least one processor and memory storing instructions. The at least one processor is configured to execute the instructions to: for each of a plurality of opponents of a negotiation, acquire history information that indicates a utility of each offer from the opponent that have been received in the negotiation, a maximum length of time of a period of the negotiation being fixed in advance; for each of the plurality of the opponents, compute an expected utility of future offers from the opponent based on the utilities indicated by the history information of the opponent; determine an acceptance threshold using a maximum value of the expected utilities of future offers; and determine whether or not to accept a current offer based on the utility of the current offer and the acceptance threshold.

The present disclosure provides a first negotiation method performed by a computer. The negotiation method comprises: acquiring history information that indicates a proposal time of a current offer from an opponent and a utility of each offer from the opponent that has been received in a negotiation, a maximum length of time of a period of the negotiation being fixed in advance; generating a probability distribution of a number of future offers based on a length of time of a remaining period of the negotiation and the proposal time of the current offer; computing an expected utility of future offers based on the probability distribution of the number of future offers and the utilities indicated by the history information; and determining whether or not to accept the current offer based on the expected utility of future offers and the utility of the current offer.

The present disclosure provides a second negotiation method performed by a computer. The negotiation method comprises: for each of a plurality of opponents of a negotiation, acquiring history information that indicates a utility of each offer from the opponent that has been received in the negotiation, a maximum length of time of a period of the negotiation being fixed in advance; for each of the plurality of the opponents, computing an expected utility of future offers from the opponent based on the utilities indicated by the history information of the opponent; determining an acceptance threshold using a maximum value of the expected utilities of future offers; and determining whether or not to accept a current offer based on the utility of the current offer and the acceptance threshold.

The present disclosure provides a first non-transitory computer-readable storage medium storing a program that causes a computer to execute the first negotiation method of the present disclosure described above.

The present disclosure provides a second non-transitory computer-readable storage medium storing a program that causes a computer to execute the second negotiation method of the present disclosure described above.

### Advantageous Effects of Invention

According to the present disclosure, a novel technique to appropriately determine whether or not to accept an offer in the negotiation is provided.

### BRIEF DESCRIPTION OF DRAWINGS

FIG. 1 illustrates an overview of the negotiation apparatus of the first example embodiment.

FIG. 2 is a block diagram illustrating an example of a functional configuration of the negotiation apparatus.

FIG. 3 is a block diagram illustrating an example of the hardware configuration of a computer realizing the negotiation apparatus.

FIG. 4 is a flowchart illustrating an example flow of process performed by the negotiation apparatus of the first example embodiment.

FIG. 5 illustrates an example structure of the history information.

FIG. 6 is a flowchart illustrating an example flow of process that is performed by the negotiation apparatus of the second example embodiment.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, a storage unit is formed with one or more storage devices.

### First Example Embodiment

### Overview

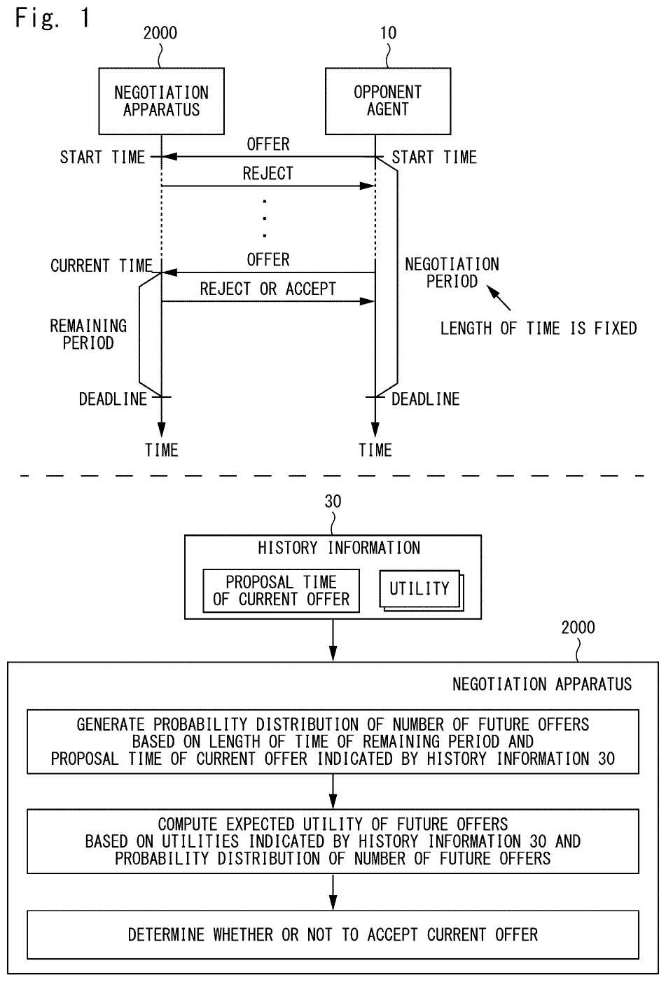

FIG. 1 illustrates an overview of the negotiation apparatus 2000 of the first example embodiment. Note that the overview illustrated by FIG. 1 shows an example of operations of the negotiation apparatus 2000 to make it easy to understand the negotiation apparatus 2000, and does not limit or narrow the scope of possible operations of the negotiation apparatus 2000.

The negotiation apparatus 2000 works as an automated agent that performs a negotiation with an opponent agent 10. The opponent agent 10 is an agent that provides an offer to the negotiation apparatus 2000. It is noted that the opponent agent 10 may be operated manually or automatically.

In this example embodiment, the number of the opponent agent 10 is assumed to be one. As described later, the negotiation apparatus 2000 of the second example embodiment handles a plurality of the opponent agents 10.

The negotiation apparatus 2000 conducts the negotiation with the opponent agent 10 under a rule of that they have to terminate the negotiation by the deadline of the negotiation. In other words, a length of a period of the negotiation is fixed in advance. Hereinafter, the period of the negotiation and its length are called “negotiation period” and “maximum negotiation time”, respectively.

The negotiation apparatus 2000 receives the offer from the opponent agent 10, and determines whether or not to accept this offer (called “current offer”). The negotiation continues when the negotiation apparatus 2000 rejects the current offer, whereas the negotiation ends when the negotiation apparatus 2000 accepts the current offer. Also, the negotiation ends when the negotiation period expires.

Whether or not to accept the current offer is determined based on a utility of the current offer. The utility of an offer is an index value that represents how preferable the offer is from the viewpoint of a party which receives the offer; the party may be a user of the negotiation apparatus 2000.

Conceptually, it is preferable for the negotiation apparatus 2000 to reject the current offer and await future offers when it is expected that the opponent agent 10 will provide an offer preferable to the current one. On the other hand, it is preferable for the negotiation apparatus 2000 to accept the current offer when it is not expected that the opponent agent 10 will provide an offer preferable to the current one. It is note that the future offer is any offer that the negotiation apparatus 2000 will receive after receiving the current offer in the negotiation.

Thus, the negotiation apparatus 2000 determines whether or not to accept the current offer based on the utility of the current offer and the expected utility of future offers. For example, the negotiation apparatus 2000 may determine to accept the current offer when the utility of the current offer is larger than or equal to the expected utility of future offers. On the other hand, the negotiation apparatus 2000 may determine to reject the current offer when the utility of the current offer is smaller than the expected utility of future offers.

The expected utility of future offers is computed using the history information 30. The history information 30 indicates the proposal time of the current offer and the utility of each offer that the negotiation apparatus 2000 has received (i.e., the current offer and the past offers). Specifically, the negotiation apparatus 2000 generates a probability distribution of the number of future offers based on the length of time of the remaining period of the negotiation (i.e., the length of time between the current time and the deadline of the negotiation) and the proposal time of the current offer. Then, the negotiation apparatus 2000 computes the expected utility of future offers based on the probability distribution of the number of future offers and the utilities indicated by the history information 30. Hereinafter, the length of time of the remaining period of the negotiation is called “remaining negotiation time”.

### Example of Advantageous Effect

Unlike the negotiation assumed in NPL1, it is not the maximum number of offers but the maximum length of time of the negotiation that is fixed in advance for the negotiation that the negotiation apparatus 2000 conducts. To handle this type of negotiation, the negotiation apparatus 2000 predicts the distribution of the number of future offers based on the remaining negotiation time, and compute the expected utility of future offers based on the predicted distribution of the number of future offers. Then, whether or not to accept the current offer is determined based on the utility of the current offer and the expected utility of future offers. By doing so, the negotiation apparatus 2000 can accurately predict whether or not the current offer is preferable to future offers in the negotiation with the maximum length of time thereof being fixed, and thereby appropriately determines whether or not to accept the current offer.

Hereinafter, more detailed explanation of the negotiation apparatus 2000 of the first example embodiment will be described.

### Example of Functional Configuration

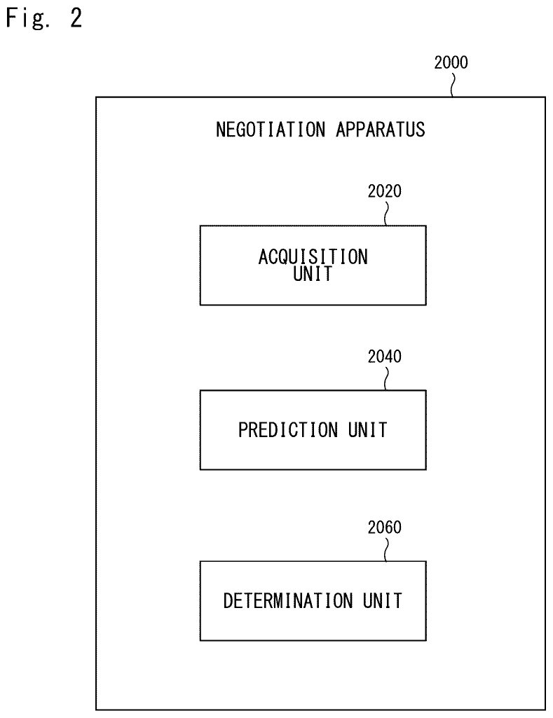

FIG. 2 illustrates an example of a functional configuration of the negotiation apparatus 2000. The negotiation apparatus 2000 includes an acquisition unit 2020, a prediction unit 2040, and a determination unit 2060. The acquisition unit 2020 acquires the history information 30. The prediction unit 2040 generates the probability distribution of the number of future offers based on the remaining negotiation time and the proposal time of the current offer. The prediction unit 2040 computes the expected utility of future offers based on the probability distribution of the number of future offers and the utilities indicated by the history information 30. The determination unit 2060 determines whether or not to accept the current offer based on the utility of the current offer and the expected utility of future offers.

### Example of Hardware Configuration

The negotiation apparatus 2000 may be realized by one or more computers. Each of the one or more computers may be a special-purpose computer manufactured for implementing the negotiation apparatus 2000, or may be a general-purpose computer like a personal computer (PC), a server machine, or a mobile device.

The negotiation apparatus 2000 may be realized by installing an application in the computer. The application is implemented with a program that causes the computer to function as the negotiation apparatus 2000. In other words, the program is an implementation of the functional units of the negotiation apparatus 2000.

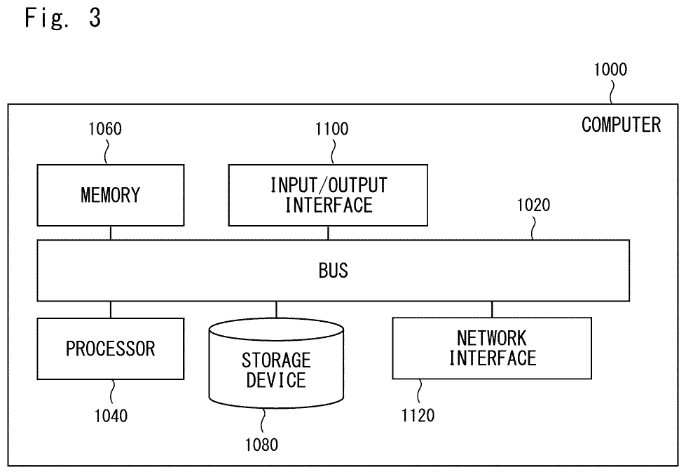

FIG. 3 is a block diagram illustrating an example of the hardware configuration of a computer 1000 realizing the negotiation apparatus 2000. In FIG. 3, the computer 1000 includes a bus 1020, a processor 1040, a memory 1060, a storage device 1080, an input/output interface 1100, and a network interface 1120.

The bus 1020 is a data transmission channel in order for the processor 1040, the memory 1060, the storage device 1080, and the input/output interface 1100, and the network interface 1120 to mutually transmit and receive data. The processor 1040 is a processer, such as a CPU (Central Processing Unit), GPU (Graphics Processing Unit), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The input/output interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The storage device 1080 may store the program mentioned above. The CPU 1040 executes the program to realize each functional unit of the negotiation apparatus 2000.

The hardware configuration of the computer 1000 is not limited to the configuration shown in FIG. 3. For example, as mentioned-above, the negotiation apparatus 2000 may be realized by plural computers. In this case, those computers may be connected with each other through the network.

### Flow of Process

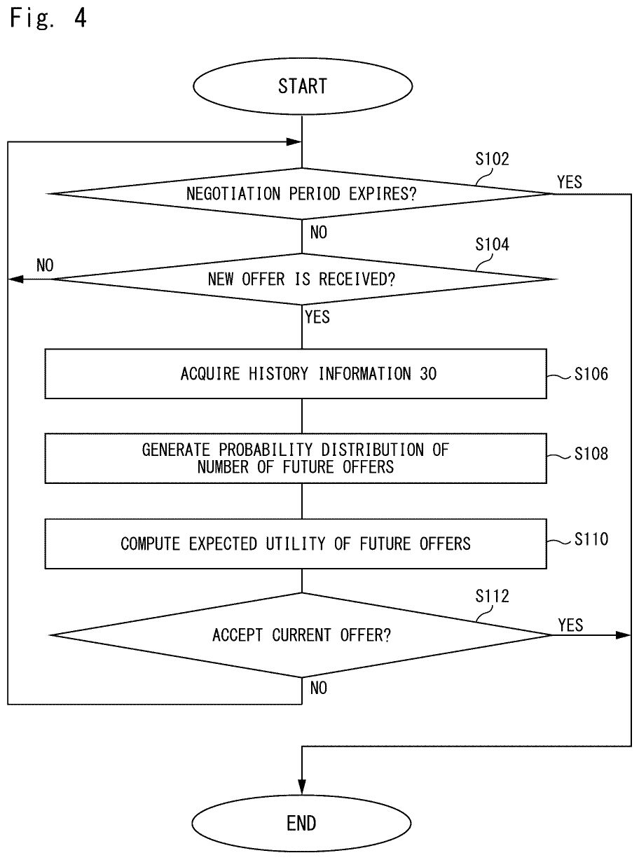

FIG. 4 is a flowchart illustrating an example flow of process that is performed by the negotiation apparatus 2000 of the first example embodiment. It is noted that the flow of process performed by the negotiation apparatus is not limited to one shown by FIG. 4.

The negotiation apparatus 2000 determines whether or not the negotiation period expires (S102). In the case where the negotiation period expires (S102: YES), the negotiation apparatus 2000 terminates the process shown by FIG. 4. On the other hand, in the case where the negotiation period does not expire (S102: NO), the negotiation apparatus 2000 determines whether or not it receives a new offer (S104). In the case where the negotiation apparatus 2000 does not receive a new offer (S104: NO), the process goes back to Step S202. Repetitive executions of Steps S102 to S104 mean that the negotiation apparatus 2000 waits for a new offer as long as the negotiation period does not expire.

In the case where the negotiation apparatus 2000 receives a new offer (S104: YES), the acquisition unit 2020 acquires the history information 30 (S106). It is noted that the new offer is handled as the current offer. The prediction unit 2040 generates the probability distribution of the number of future offers based on the remaining negotiation time and the proposal time of the current offer (S108). The remaining negotiation time may be computed by subtracting the current time from the deadline of the negotiation. The prediction unit 2040 computes the expected utility of future offers based on the probability distribution of the number of future offers and the utilities indicated by the history information 30 (S110).

The determination unit 2060 determines whether or not to accept the current offer based on the utility of the current offer and the expected utility of future offers (S112). In the case where the determination unit 2060 determines not to accept the current offer (S112: NO), the process goes back to Step S102 to continue the negotiation. On the other hand, in the case where the determination unit 2060 determines to accept the current offer (S112: YES), the process shown by FIG. 4 terminates.

### Acquisition of History Information 30: S106

The acquisition unit 2020 acquires the history information 30 (S106). The history information 30 indicates the proposal time of the current offer and the utility of each offer that the negotiation apparatus 2000 has receives (i.e., the past offers and the current offer). It is noted that the history information 30 may additionally indicate the proposal times of the past offers.

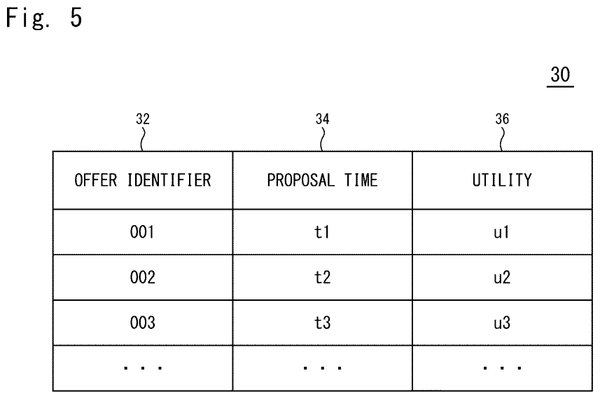

FIG. 5 illustrates an example structure of the history information 30. The history information 30 has three columns: an offer identifier 32; a proposal time 34; and a utility 36. The history information has a row for each offer. The offer identifier 32 of a row indicates an identifier (e.g., sequence number) of the offer corresponding to the row. The proposal time 34 of a row indicates the proposal time of the offer corresponding to the row: e.g., the time at which the negotiation apparatus receives the corresponding offer. It is noted that, unless otherwise stated, the start time of the negotiation is set as 0, and therefore the proposal time of the offer is equivalent to the length of time from the start time of the negotiation to the time at which the offer is received. The utility 36 of a row indicates the utility of the offer corresponding to the row. For example, the first row of the history information 30 shown by FIG. 5 represents that the proposal time and the utility of the offer 001 are t1 and u1, respectively.

It is noted that the utility of the offer is computed based on one or more contents of the offers. The contents of the offer depend of the negotiation. Suppose that the opponent agent 10 tries to sell products to the user of the negotiation apparatus 2000. In this case, the offer may include the number of products, the price of the products, the delivery time of the products, etc.

In some embodiments, the utility of the offer is computed using a utility function that takes one or more values representing the contents of the offer, and outputs a real value representing the utility of the offer. The utility function may convert each of the contents of the offer into a score, and computes a weighted sum of the scores as the utility of the offer.

The history information 30 may be updated when the negotiation apparatus 2000 receives the current offer. Specifically, the negotiation apparatus 2000 may compute the utility of the current offer, generate a new piece of information (e.g., a new row of the table shown by FIG. 5) of the history information 30 for the current offer, and add this new piece of information to the history information 30.

There are various methods to acquire the history information 30. In some implementations, the history information 30 is stored in advance in a storage unit in a manner that the acquisition unit 2020 can acquire the history information 30 therefrom. In this case, the acquisition unit 2020 may access to the storage unit and acquire the history information 30 from the storage unit. In other implementations, the acquisition unit 2020 may receive the history information 30 that is sent from another computer.

### Utility of Future Offers: S108, S110

As mentioned above, the prediction unit 2040 computes the expected utility of future offers (S110). The expected utility of future offers may depend on the number of future offers. However, the number of future offers cannot be specified since it is not the maximum number of offers but the maximum length of the negotiation that is specified in the negotiation between the negotiation apparatus 2000 and the opponent agent 10.

Thus, the prediction unit 2040 may compute the expected utility of future as follows:

$$E = {\sum }_{k = 1}^{kmax} P ( k ) E ( k ) \qquad ( 1 )$$

wherein E represents the expected utility of future offers without the condition of the number of feature offers; k represents the number of future offers; P(k) represents the probability distribution of the number of future offers, i.e., P(k) represents the probability of the number of future offers being k; and E(k) represents the expected utility of future offers under the condition that the number of future offers is k (in other words, the expected utility of future offers with the fixed number k of future offers). It is noted that, although kmax is +∞ theoretically, arbitrary integer value may be set to kmax so as to terminate computation of the equation (1) in a feasible length of time.

The prediction unit 2040 may obtain P(k) and E(k), and computes the expected utility E of future offers by applying the obtained P(k) and E(k) to the equation (1). Hereinafter, example ways of obtaining P(k) and those of obtaining E(k) will explained below.

### Probability Distribution of Number of Future Offers

The prediction unit 2040 generates the probability distribution of the number of future offers, i.e., P(k), based on the remaining negotiation time and the proposal time of the current offer (S108). In some embodiments, the probability distribution of the number of future offers can be modeled as follows:

### Equation 2

$$P ( k ) = \frac{{{T}^{k} ( {t}_{c} )}^{c} ( k + c - 1 ) !}{k ! ( c - 1 ) ! {( T + {t}_{c} )}^{k + c}} \qquad ( 2 )$$

wherein k represents the number of future offers; P(k) represents the probability mass function of k, i.e., P(k) represents the probability of the number of future offers being k; T represents the remaining negotiation time; c represents the index of the current offer; and t_c represents the proposal time of the current time.

Hereinafter, how to introduce the equation (2) will be explained. How many future offers the negotiation apparatus 2000 will receive may depend on how often the negotiation apparatus 2000 will receive a future offer. Thus, the probability distribution of the number of future offers can be computed based on the probability distribution of the frequency of future offers being received.

The probability distribution of the frequency of future offers being received may be modeled as follows:

### Equation 3

$$f ( λ ) = \frac{{( {t}_{c} )}^{c}}{c - 1} {λ}^{c - 1} {e}^{- {t}_{c} λ} \qquad ( 3 )$$

wherein f(λ) represents the probability density function of A; and A represents the frequency of future offers being received.

Using the probability distribution f(λ), the probability distribution of the number of future offers can be formulated as follows:

### Equation 4

$$\begin{matrix}P ( k ) = {\int }_{0}^{+ ∞} \frac{{( T λ )}^{k} {e}^{- \{ T λ )}}{k !} f ( λ ) d λ \\ = \frac{{{T}^{k} ( {t}_{c} )}^{c} ( k + c - 1 ) !}{k ! ( c - 1 ) ! {( T + {t}_{c} )}^{k + c}}\end{matrix} \qquad ( 4 )$$

### Utility of Future Offers with Fixed Number of Future Offers

The negotiation apparatus 2000 generates a conditional utility function E(k) (i.e., computes the expected utility of future offers under the condition that the number of future offers is k). First, the negotiation apparatus 2000 predicts distribution of the utility of the future offer. It may be predicted based on the history of the utilities of offers indicated by the history information 30.

In some embodiment, the prediction unit 2040 predicts the distribution of the utility of the future offer using Gaussian Process Regression. Specifically, the prediction unit 2040 may compute differences for each pair of utilities that are adjacent in time as follows:

### Equation 5

$$Δ {u}_{i} = {u}_{i + 1} - {u}_{i} ( i = 1 , … , c - 1 ) \qquad ( 5 )$$

wherein i represents the index of an offer; u_i represents the utility of the i-th offer; and c represents the index of the current offer.

Then, the prediction unit 2040 applies pairs of the index of the offer and the difference of the utilities of adjacent offers, i.e., (i, Δu_i) for i=1 to c, to Gaussian Process Regression as input, and thereby obtaining Gaussian distribution of the difference of utilities of adjacent future offers. Specifically, the prediction unit 2040 can obtain a pair of mean and variance of Gaussian distribution of the difference of utilities of adjacent future offers.

Then, the prediction unit 2040 may generate Gaussian distribution of the utility of the feature offer by computing its mean and variance as follows:

### Equation 6

$$\begin{matrix}{m}_{j} = {u}_{c} + {\sum }_{n = c}^{j - 1} Δ {m}_{n} \\ {v}_{j}^{2} = {\sum }_{n = c}^{j - 1} Δ {v}_{n}^{2} \\ with j > c\end{matrix} \qquad ( 6 )$$

wherein m_j and (v_j)\hat{ }2 respectively represent the predicted mean and variance of Gaussian distribution of the utility of the j-th offer; Δm_n and Δ(v_n)\hat{ }2 respectively represent the predicted mean and variance of Gaussian distribution of the difference between the utility of the n-th offer and that of the (n+1)-th offer.

It is noted that since the prediction unit 2040 applies the difference of utilities between adjacent offers to Gaussian process regression, it can predict the utility of the future offer more precisely than the case where the utilities of the offers indicated by the history information 30 are directly applied to Gaussian process regression. However, in other embodiments, the prediction unit 2040 may directly apply the utilities of the offers indicated by the history information 30 to Gaussian process regression to obtain Gaussian distribution of the utility of the future offer. More specifically, pairs of the index and the utility of the offer, i.e., (i, u_i) for i=1 to c, are fed to Gaussian Process Regression as input, thereby obtaining Gaussian distribution of the utility of future offer. It is noted that u_i represents the utility of the i-th offer.

Using the distribution of the utility of the future offer that is predicted as above, the prediction unit 2040 computes the expected utility of future offers under the condition that the number of future offers is k, i.e., E(k). The prediction unit 2040 may compute E(k) as follows:

### Equation 7

$$\begin{matrix}E {( k )}_{k} = {\int }_{a}^{b} ( 1 - {F ( x )}_{k} ) dx \\ E {( k )}_{j} = {E ( k )}_{j + 1} + {\int }_{{E ( k )}_{j + 1}}^{b} ( 1 - {F ( x )}_{j} ) dx ( j = c + 1 , c + 2 , … , k - 1 ) \\ E ( k ) = {E ( k )}_{c + 1}\end{matrix} \qquad ( 7 )$$

wherein E(k)_j represents the expected utility of the j-th offer under the condition that the number of future offers is k; F(x)_j represents the truncated cumulative distribution function (CDF) of Gaussian distribution of the utility of j-th offer; a and b are the smallest value and the largest value of the range of the utility, respectively. Thus, in the case where the utilities are normalized into [0,1], a and b are set to be 0 and 1, respectively.

It is noted that, in order to reduce the computation time of the above equation (7), the prediction unit 2040 may compute the equation (7) using the following equation.

### Equation 8

$${E ( k )}_{j + 1} = \{ {E ( k )}_{j + 2} ( Φ ( \frac{{E ( k )}_{j + 2} - {m}_{j + 1}}{{v}_{j + 1}} ) - Φ ( \frac{a - {m}_{j + 1}}{{v}_{j + 1}} ) ) + ( {m}_{j + 1} + \frac{φ ( \frac{{E ( k )}_{j + 2} - {m}_{j + 1}}{{v}_{j + 1}} ) - φ ( \frac{b - {m}_{j + 1}}{{v}_{j + 1}} )}{Φ ( \frac{b - {m}_{j + 1}}{{v}_{j + 1}} ) - Φ ( \frac{a - {m}_{j + 1}}{{v}_{j + 1}} )} {v}_{j + 1} ) ( Φ ( \frac{b - {m}_{j + 1}}{{v}_{j + 1}} ) - Φ ( \frac{{E ( k )}_{j + 2} - {m}_{j + 1}}{{v}_{j + 1}} ) ) \} / \{ Φ ( \frac{b - {m}_{j + 1}}{{v}_{j + 1}} ) - Φ ( \frac{a - {m}_{j + 1}}{{v}_{j + 1}} ) \} \qquad ( 8 )$$

wherein Φ and φ represents CDF and probability density function (PDF) of the standard normal distribution, respectively.

### Determination of Acceptance: S108

The determination unit 2060 determines whether or not to accept the current offer based on the utility of the current offer and the expected utility of future offers (S108). To do so, the determination unit 2060 may determine whether or not the utility of the current offer is larger than or equal to a threshold Th named “acceptance threshold”, which is defined based on the expected utility of future offers. When the current offer is larger than or equal to the acceptance threshold, the determination unit 2060 determines to accept the current offer. On the other hand, when the current offer is smaller than the acceptance threshold, the determination unit 2060 determines to reject (in other words, not to accept) the current offer.

In some implementations, the determination unit 2060 may set the expected utility of future offers to the acceptance threshold. In other implementations, the determination unit 2040 may set the expected utility of future offers plus a margin to the acceptance threshold Th: Th=E+α wherein E is the expected utility of future offers and a is the margin. The margin a may be defined based on a benefit of an early conclusion of the negotiation; the longer the remaining negotiation time is, the larger the margin a could be defined to be. This is because that concluding the negotiation earlier could be more beneficial for the user of the negotiation apparatus 2000 than waiting for future offers that are only slightly preferable to the current offer in terms of the utility.

### Output from Negotiation Apparatus 2000

The negotiation apparatus 2000 may output information based on the result of the determination regarding the current offer. Hereinafter, this information is called “output information”. The output information may be a response to the current offer. In this case, the negotiation apparatus 2000 may send the output information to the opponent agent 10. The response indicates the acceptance or rejection of the current offer. In addition, the response may also indicate a counter offer. It is noted that there are various well-known ways to propose a counter offer based on the received offer, and one of those way may be employed in the negotiation apparatus 2000.

In addition, the negotiation apparatus 2000 may output the output information to notify the result of determination regarding the current offer of the user of the negotiation apparatus 2000. In this case, the output information may include any information that is useful for the user, such as whether or not the current offer is accepted, and the expected utility of future offers.

The output information may be output in various manners. In some embodiments, the negotiation apparatus 2000 may put the output information in a storage unit. In other embodiments, the negotiation apparatus 2000 may output the output information to a display device, and cause the display device to display the output information. In other embodiments, the negotiation apparatus 2000 may send the output information to another computer, such as the opponent agent 10 or a user device (e.g., a PC or a smartphone) of the user of the negotiation apparatus 2000.

### Second Example Embodiment

### Overview

The negotiation apparatus 2000 of the second example embodiment conducts the negotiation with two or more opponent agents 10. Thus, the negotiation apparatus 2000 may accept an offer from one of the multiple opponent agents 10, and reject offers from the rest of them.

To handle multiple opponent agents 10, the negotiation apparatus 2000 computes the expected utility of future offers for each opponent agent 10, which are denoted by E1, E2, . . . , and EA, respectively, wherein A represents the number of the opponent agents 10. It is noted that the negotiation apparatus 2000 acquires the history information 30 for each opponent agent 10 in this example embodiment. The history information 30 of an opponent agent 10 indicates the proposal time of the current offer from the opponent agent 10 and the utility of each offer from the opponent agent 10 that has been received by the negotiation apparatus 2000.

Like the negotiation apparatus 2000 of the first example embodiment, the negotiation apparatus 2000 of the second example embodiment determines whether not to accept the current offer by comparing the utility of the current offer and the acceptance threshold. However, a way that the negotiation apparatus 2000 of the second example embodiment determines the acceptance threshold is different from the way that the negotiation apparatus 2000 of the second example does. Specifically, the negotiation apparatus 2000 determines the acceptance threshold based on a set of the expected utilities of future offers computed for the respective opponent agents 10, i.e., {E1, E2, . . . , EA}. Hereinafter, this set is called “expected utility set” and denoted by S, i.e., S={E1, E2, . . . , EA}. For example, the largest value in the expected utility set S may be set to the acceptance threshold.

### Example of Advantageous Effect

According to the negotiation apparatus 2000 of the second example embodiment, it is possible to appropriately determine whether or not accept the current offer in the negotiation where there are multiple opponents and where not the maximum number of future offers but the maximum length of time of the negotiation is fixed in advance.

Hereinafter, more detailed explanation of the negotiation apparatus 2000 of the second example embodiment will be described.

### Example of Functional Configuration

The functional configuration of the negotiation apparatus 2000 of the second example embodiment may be illustrated by FIG. 2, like the negotiation apparatus 2000 of the first example embodiment. The acquisition unit 2020 of the second example embodiment acquires the history information 30 for each opponent agent 10. For each opponent agent 10, the prediction unit 2040 computes the expected utility of future offers from the opponent agent 10. The determination unit 2060 determines the acceptance threshold based on the expected utilities of future offers from the respective opponent agents 10, and determines whether or not to accept the current offer based on the utility of the current offer and the acceptance threshold.

### Example of Hardware Configuration

The negotiation apparatus 2000 of the second example embodiment may be realized by one or more computers similar to those realizing the negotiation apparatus 2000 of the first example embodiment. Thus, its hardware configuration may also be depicted by FIG. 3. However, the storage device 1080 of the second example embodiment may include the program that causes the computer 1000 to function as the negotiation apparatus 2000 of the second example embodiment.

### Flow of Process

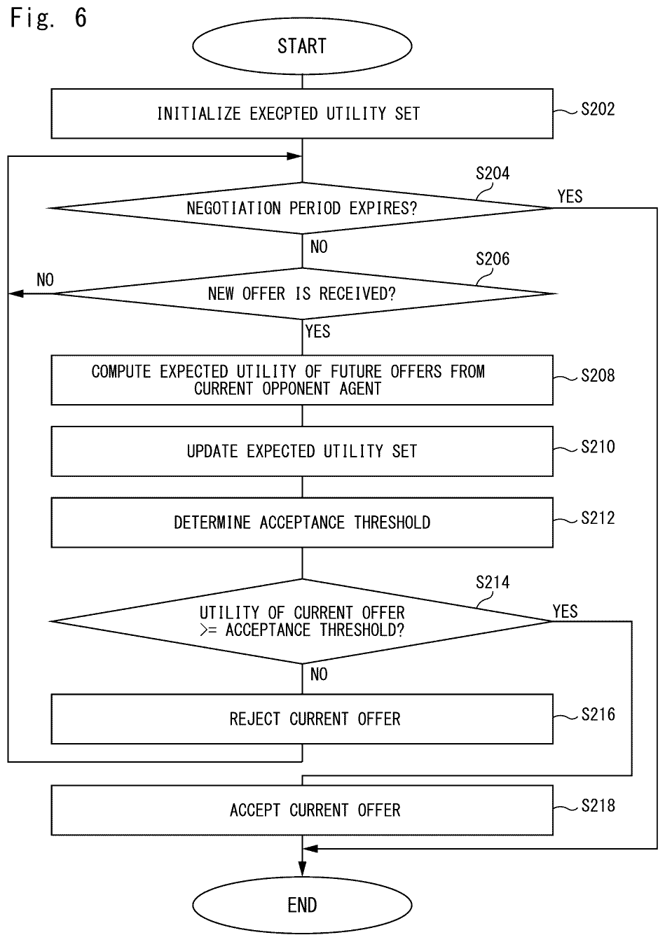

FIG. 6 is a flowchart illustrating an example flow of process that is performed by the negotiation apparatus 2000 of the second example embodiment. It is noted that the flow of process performed by the negotiation apparatus is not limited to one shown by FIG. 6.

The negotiation apparatus 2000 initialize the expected utility set (S202). The expected utility set may be initialized to indicate 0 for each opponent agent. Then, like the negotiation apparatus 2000 of the first example embodiment, the negotiation apparatus 2000 of the second example embodiment waits for a new offer as long as the negotiation period does not expire (S204 and S206).

When it is determined that the negotiation apparatus 2000 receives a new offer (S206: YES), the prediction unit 2040 computes the expected utility of future offers from the opponent agent 10 that sends the new offer (i.e., current offer) (S208). Hereinafter, the opponent agent 10 that sends the current offer is called “current opponent agent”. The prediction unit 2040 updates the expected utility set with the expected utility of future offers from the current opponent agent that is computed at Step S208 (S210). The determination unit 2060 determines the acceptance threshold using the expected utility set that is updated at Step S210 (S212).

The determination unit 2060 determines whether or not the utility of the current offer is larger than or equal to the acceptance threshold (S214). In the case where the utility of the current offer is larger than or equal to the acceptance threshold (S214: YES), the determination unit 2060 determines to accept the current offer (S218). Thus, the process shown by FIG. 6 terminates. On the other hand, in the case where the utility of the current offer is not larger than or equal to the acceptance threshold (S214: NO), the determination unit 2060 determines to reject the current offer (S216). Thus, the process shown by FIG. 6 goes back to S204 to continue the negotiation.

### Computation of Expected Utility of Future Offers: S208

In response to that the negotiation apparatus 2000 receives the new offer, the prediction unit 2040 computes the expected utility of future offers from the current opponent agent (S208). To do so, the acquisition unit 2020 acquires the history information 30 of the current opponent agent. Then, the prediction unit 2040 generates the probability distribution of the number of future offers from the current opponent agent, which corresponds to P(k) in the equation (1), based on the remaining negotiation time and the proposal time of the current offer. The concrete ways of generating the probability distribution of the number of future offers from an opponent agent 10 are already explained in the first example embodiment.

The prediction unit 2040 also computes the expected utility of future offers from the current opponent agent given the number of future offers, which corresponds to E(k) in the equation (1), based on the utilities that are indicated by the history information 30 of the current opponent agent. The concrete ways of computing the expected utility of future offers from an opponent agent given the number of future offers are already explained in the first example embodiment.

Then, the prediction unit 2040 computes the expected utility of future offers from the current opponent agent without the condition of the number of future offers, which corresponds to E in the equation (1), based on the expected utility of future offers from the current opponent agent given the number of future offers and the probability distribution of the number of future offers from the current opponent agent. In other words, the prediction unit 2040 computes the expected utility E of the current opponent agent by applying P(k) and E(k) of the current opponent agent to the equation (1).

### Update of Expected Utility Set: S210

The prediction unit 2040 updates the expected utility set with the expected utility of future offers from the current opponent agent. Suppose that an element S[i] of the expected utility set S represents the expected utility of future offers from the opponent agent 10 with an identifier i, and the current opponent agent has the identifier j. In this case, the prediction unit 2040 updates S[j] with the expected utility of future offers from the current opponent agent that is computed at Step S208.

### Determination of Acceptance Threshold: S212

The determination unit 2060 determines the acceptance threshold using the expected utility set. Basically, if the expected utility set includes a value larger than the utility of the current offer, it is preferable for the negotiation apparatus 2000 not to accept the current offer since it is expected that the negotiation apparatus 2000 will receive an offer preferable to the current one.

Thus, in some embodiments, the negotiation apparatus 2000 may set the largest value in the expected utility set S to the acceptance threshold. In this case, the negotiation apparatus 2000 determines to accept the current offer only when the utility of the current offer is larger than or equal to every one of the expected utilities of future offers from the opponent agents 10.

In other embodiments, like the first example embodiment, the negotiation apparatus 2000 of the second example embodiment may include a margin in the acceptant threshold. Specifically, the determination unit 2040 may set the largest value in the expected utility set plus a margin to the acceptance threshold Th: Th=EL+α wherein EL is the largest value in the expected utility set and a is the margin.

### Termination of Negotiation

The negotiation apparatus 2000 terminates the negotiation with the multiple opponent agents 10 when it accepts the current offer. For example, the negotiation apparatus 2000 notifies the termination of the negotiation of each opponent agent 10. Regarding the current opponent agent, the negotiation apparatus 2000 may send a response that indicates the acceptance of the current offer. This response may also mean the termination of the negotiation.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The programs mentioned in this disclosure include instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

This application is based upon and claims the benefit of priority from Japanese patent application No. 2021-214132, filed on Dec. 28, 2021, the disclosure of which is incorporated herein in its entirety by reference.

### REFERENCE SIGNS LIST

10 opponent agent
30 history information
32 offer identifier
34 proposal time
36 utility
1000 computer
1020 bus
1040 processor
1060 memory
1080 storage device
1100 input/output interface
1120 network interface
2000 negotiation apparatus
2020 acquisition unit
2040 prediction unit
2060 determination unit

1. A negotiation apparatus comprising:
at least one processor; and
memory storing instructions;
wherein the at least one processor is configured to execute the instructions to:
acquire history information that indicates a proposal time of a current offer from an opponent and a utility of each offer from the opponent that has been received in a negotiation, a maximum length of time of a period of the negotiation being fixed in advance;
generate a probability distribution of a number of future offers based on a length of time of a remaining period of the negotiation and the proposal time of the current offer;
compute an expected utility of future offers based on the probability distribution of the number of future offers and the utilities indicated by the history information; and
determine whether or not to accept the current offer based on the expected utility of future offers and the utility of the current offer.

2. The negotiation apparatus according to claim 1,
wherein the generation of the probability distribution of the number of future offers includes: applying the length of time of the remaining period of the negotiation and the proposal time of the current offer to parameters of a predefined model of the probability distribution of the number of future offers.

3. The negotiation apparatus according to claim 1,
the computation of the expected utility of future offers includes:
generating a conditional expected utility function that takes the number of future offers as an input and outputs the expected utility of future offers with the condition that the number of future offers is represented by the input; and
computing the expected utility of future offers based on the conditional expected utility function and the probability distribution of the number of future offers.

4. The negotiation apparatus according to claim 3,
the generation of the conditional expected utility function includes:
computing a difference of the utility for each pair of the utilities adjacent to each other in time indicated by the history information;
applying the computed differences of the utility to Gaussian process regression to obtain Gaussian distributions of difference of the utility in future offers; and
computing the expected utility of each future offer based on the Gaussian distributions of difference of the utility in future offers.

5. The negotiation apparatus according to claim 1,
wherein the negotiation is conducted with a plurality of the opponents,
wherein the expected utility of future offers is computed for each of the opponents, and
wherein the determination of whether or not to accept the current offer includes:
determining an acceptance threshold using a maximum value of the expected utilities of future offers; and
determining to accept the current offer in the case where the utility of the current offer is larger than or equal to the acceptance threshold.

6. (canceled)

7. A negotiation method performed by a computer, comprising:
acquiring history information that indicates a proposal time of a current offer from an opponent and a utility of each offer from the opponent that has been received in a negotiation, a maximum length of time of a period of the negotiation being fixed in advance;
generating a probability distribution of a number of future offers based on a length of time of a remaining period of the negotiation and the proposal time of the current offer;
computing an expected utility of future offers based on the probability distribution of the number of future offers and the utilities indicated by the history information; and
determining whether or not to accept the current offer based on the expected utility of future offers and the utility of the current offer.

8. (canceled)

9. A non-transitory computer-readable storage medium storing a program that causes a computer to execute:
acquiring history information that indicates a proposal time of a current offer from an opponent and a utility of each offer from the opponent that has been received in a negotiation, a maximum length of time of a period of the negotiation being fixed in advance;
generating a probability distribution of a number of future offers based on a length of time of a remaining period of the negotiation and the proposal time of the current offer;
computing an expected utility of future offers based on the probability distribution of the number of future offers and the utilities indicated by the history information; and
determining whether or not to accept the current offer based on the expected utility of future offers and the utility of the current offer.

10. (canceled)

11. The negotiation method according to claim 7,
wherein the generation of the probability distribution of the number of future offers includes: applying the length of time of the remaining period of the negotiation and the proposal time of the current offer to parameters of a predefined model of the probability distribution of the number of future offers.

12. The negotiation method according to claim 7,
the computation of the expected utility of future offers includes:
generating a conditional expected utility function that takes the number of future offers as an input and outputs the expected utility of future offers with the condition that the number of future offers is represented by the input; and
computing the expected utility of future offers based on the conditional expected utility function and the probability distribution of the number of future offers.

13. The negotiation method according to claim 12,
the generation of the conditional expected utility function includes:
computing a difference of the utility for each pair of the utilities adjacent to each other in time indicated by the history information;
applying the computed differences of the utility to Gaussian process regression to obtain Gaussian distributions of difference of the utility in future offers; and
computing the expected utility of each future offer based on the Gaussian distributions of difference of the utility in future offers.

14. The negotiation method according to claim 7,
wherein the negotiation is conducted with a plurality of the opponents,
wherein the expected utility of future offers is computed for each of the opponents, and
wherein the determination of whether or not to accept the current offer includes:
determining an acceptance threshold using a maximum value of the expected utilities of future offers; and
determining to accept the current offer in the case where the utility of the current offer is larger than or equal to the acceptance threshold.

15. The non-transitory computer-readable storage medium according to claim 9,
wherein the generation of the probability distribution of the number of future offers includes: applying the length of time of the remaining period of the negotiation and the proposal time of the current offer to parameters of a predefined model of the probability distribution of the number of future offers.

16. The non-transitory computer-readable storage medium according to claim 9,
the computation of the expected utility of future offers includes:
generating a conditional expected utility function that takes the number of future offers as an input and outputs the expected utility of future offers with the condition that the number of future offers is represented by the input; and
computing the expected utility of future offers based on the conditional expected utility function and the probability distribution of the number of future offers.

17. The non-transitory computer-readable storage medium according to claim 16,
the generation of the conditional expected utility function includes:
computing a difference of the utility for each pair of the utilities adjacent to each other in time indicated by the history information;
applying the computed differences of the utility to Gaussian process regression to obtain Gaussian distributions of difference of the utility in future offers; and
computing the expected utility of each future offer based on the Gaussian distributions of difference of the utility in future offers.

18. The non-transitory computer-readable storage medium according to claim 9,
wherein the negotiation is conducted with a plurality of the opponents,
wherein the expected utility of future offers is computed for each of the opponents, and
wherein the determination of whether or not to accept the current offer includes:
determining an acceptance threshold using a maximum value of the expected utilities of future offers; and
determining to accept the current offer in the case where the utility of the current offer is larger than or equal to the acceptance threshold.
